(19) United States
(12) Patent Application Publication
(10) Pub. No.: US 2008/0148052 A1
(43) Pub. Date: Jun. 19, 2008

(54) METHOD AND SYSTEM FOR AUTHENTICATION BONDING TWO DEVICES AND SENDING AUTHENTICATED EVENTS

(75) Inventor: Brett L. Lindsley, Wheaton, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/552,668

(22) Filed: Oct. 25, 2006

(51) Int. Cl. H04L 9/00

(52) U.S. Cl. 713/169

(57) ABSTRACT

A method (20) and system (100) for sending authenticated events from a first device (36) to a second device (32) can include creating (21) a bond between the first and second device, creating (27) a signed event on the first device, and sending (28) the signed event from the first device to the second device, where the second device authenticates the signed event. The bond can be created by the first device signing (22) its device certificate (102) to create an authentication bonding object (ABO). The ABO can be transferred (23) from the first device to the second device. The second device can authenticate (24) a certificate signature or authenticate a first device signature. The second device can authorize (25) ABOs based on phone numbers. The second device can authenticate (29) an event by authenticating the signed event with a public key obtained from a certificate obtained from an ABO.

### FIELD

This invention relates generally to associating two devices, and more particularly to a method and system for associating two devices and sending an authenticated event between them.

### BACKGROUND

Associating two communication devices such as a cellular phone and a set top box or two cellular phones or a cellular phone with any number of accessories can present a number of challenges not to mention the challenges associated with authenticating events between such devices. Many bonding processes are specific to the type of transport (e.g. Bluetooth bonding or SSL over IP). In general, there are no known ways to simply use a phone number or other simple mechanism that can simply bond or authorize access among two devices and have such a system flexible enough to be used over various transports and protocols. Once the devices have been bonded together, if an event is sent from a handset to a target device, a mechanism is needed to enable the target device to authenticate the events.

A related technology can include secure transport such as secure sockets layer (SSL). In SSL, the goal is to establish a point-to-point connection using certificates. However, SSL is a transport level technology and only applies to end-to-end IP. Additionally, SSL fails to provide an authorization step to allow a device to be authorized based on the phone number.

Although there are many schemes for bonding devices together, there are no known schemes using a signed certificate to authenticate the devices followed by using the handset phone number for authorizing it. Although use of PINs or random keys to bond devices together as similarly done in Bluetooth bonding (where a device has a built-in PIN in an accessory (e.g., a headset) and the PIN is then entered into the handset), such a scheme fails to enable further transactions as contemplated herein.

### SUMMARY

Embodiments in accordance with the present invention can provide a method and system method for sending authenticated events from a first device to a second device by creating a bond between the first device and the second device, creating a signed event on the first device, and sending the signed event from the first device to the second device where the second device authenticates the signed event. Furthermore, the method can use a phone number as a mechanism to authorize access. The phone number is part of the information that can be guaranteed to be authentic since it is part of the phone certificate issued by a Certificate Authority. A certificate authority (CA) is an authority in a network that issues and manages security credentials and public keys for message encryption.

In a first embodiment of the present invention, a method of authentication bonding between communication devices can include the steps of transferring an authentication bonding object (ABO) from a wireless device to a target device and sending unique authorization information from the wireless device to the target device. The wireless device can be a cellular phone, smart phone or other similar device while the target device can be a set top box, a personal computer, a laptop computer, a call handling center server or a second cellular phone. The transfer of the ABO can be done using Bluetooth object push or by radio frequency identification (RFID) by placing the wireless device within proximity of the target device. The unique authorization information can be a phone number although the embodiments of the present invention are not necessarily to a phone number. Obtaining the phone number or unique authorization information can be done by manual entry, by retrieval from a contact list or phone book, or from Caller ID. The method can further include the step of sending an event to the target device where the target device authenticates the event. Note, an event can be sent using any transport (such as Bluetooth, 802.11, or Ethernet) over any protocol (such as HTTP, OBEX, or SMTP) as long as the transport and protocol support an object push operation. The method can further include the step of generating a list of devices currently bonded together using a list of phone numbers.

In a second embodiment of the present invention, another method for sending authenticated events from a first device to a second device can include the steps of creating a bond between the first device and the second device, creating a signed event on the first device, and sending the signed event from the first device to the second device, where the second device authenticates the signed event. The bond can be created by the first device signing its device certificate to create an authentication bonding object (ABO). The ABO can be transferred from the first device to the second device. The second device can authenticate a certificate signature or alternatively authenticate a first device signature. The second device can also authorize ABOs based on phone numbers. The phone numbers can be obtained by manual entry at the second device, from a contact list in the second device, or from a caller ID decoder at the second device. The second device can authenticate an event by authenticating the signed event with a public key obtained from a certificate obtained from an authentication bonding object.

In a third embodiment of the present invention, a system for sending authenticated events from a first device to a second device can include a transceiver or transmitter in the first device and a processor coupled to the transceiver or the transmitter. The processor can be programmed to create a bond between the first device and the second device, create a signed event on the first device, and send the signed event from the first device to the second device, where the second device authenticates the signed event. The system can create the bond by having the first device sign its device certificate to create an authentication bonding object and by transferring the authentication bonding object from the first device to the second device. As noted above, the first device can be a cellular phone and the second device can be a set top box, a personal computer, a laptop computer, a call handling center server or a second cellular phone as examples. Also note, the second device can authorizes authentication bonding objects based on phone numbers where the phone numbers are obtained by manual entry at the second device, from a contact list in the second device, or from a caller ID decoder at the second device.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a flow chart of a method of authentication bonding between communication devices in accordance with an embodiment of the present invention.

FIG. 2 is flow chart of method for sending authenticated events from a first device to a second device in accordance with an embodiment of the present invention.

FIG. 3 is an illustration of alternative ways to transfer an authentication bonding object to authorize a handset in accordance with the embodiments of the present invention.

FIG. 4 is an illustration of alternative ways to send an event in accordance with an embodiment of the present invention.

FIG. 5 is an illustration of a mechanism of authorizing an event manually at a target device in accordance with an embodiment of the present invention.

FIG. 6 is an illustration of a mechanism of authorizing an event at a target device using a contact or phone list in accordance with an embodiment of the present invention.

FIG. 7 is a flow diagram between a handset and a target device representative of a method of bonding two devices and authenticating an event in accordance with an embodiment of the present invention.

FIG. 8 is another flow diagram between two portable wireless devices in accordance with an embodiment of the present invention.

FIG. 9 is another flow diagram between a portable wireless device or handset and a call handling center.

FIG. 10 is a block diagram for a system that bonds two devices and authenticates an event in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

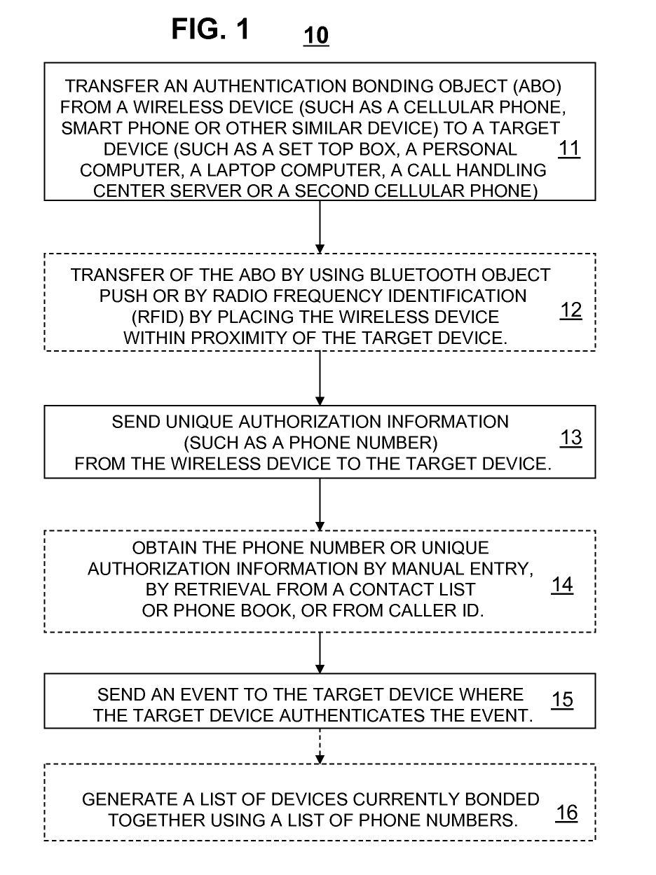

Referring to FIG. 1, a method 10 of authentication bonding between communication devices can include the step 10 of transferring an authentication bonding object (ABO) from a wireless device (such as a cellular phone, smart phone or other similar device) to a target device (such as a set top box, a personal computer, a laptop computer, a call handling center server or a second cellular phone) and sending at step 13 unique authorization information from the wireless device to the target device. The transfer of the ABO can optionally be done at step 12 using Bluetooth object push or by radio frequency identification (RFID) by placing the wireless device within proximity of the target device. The ABO can also be sent in any other number of ways including sending an e-mail or e-mail attachment, an instant message or even providing a URL link that contains the information. The unique authorization information can be a phone number although the embodiments of the present invention are not necessarily to a phone number. Obtaining the phone number or unique authorization information can be done at step 13 by manual entry, by retrieval from a contact list or phone book, or from Caller ID. The method 10 can further include the step 15 of sending an event to the target device where the target device authenticates the event. Note, an event can be sent using any transport (such as Bluetooth, 802.11, or Ethernet) over any protocol (such as HTTP, OBEX, or SMTP) as long as the transport and protocol support an object push operation. The method 10 can further include the step 16 of generating a list of devices currently bonded together using a list of phone numbers.

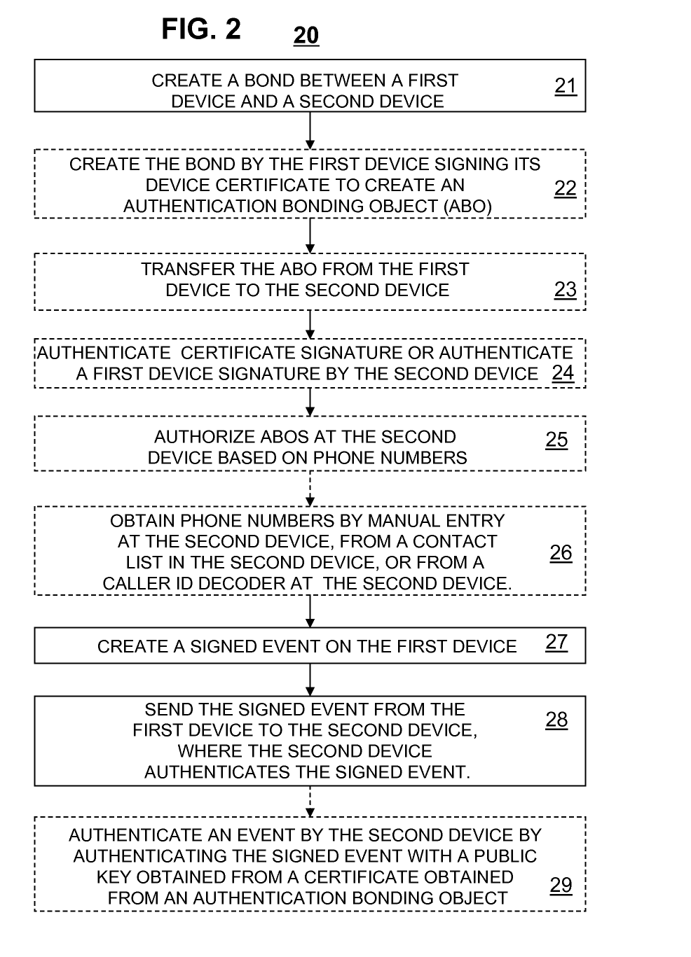

Referring to FIG. 2, another method 20 for sending authenticated events from a first device to a second device can include the step 21 of creating a bond between the first device and the second device, creating a signed event on the first device at step 27, and sending the signed event from the first device to the second device at step 28, where the second device authenticates the signed event. The bond can be created at step 22 by the first device signing its device certificate to create an authentication bonding object (ABO). The ABO can be transferred from the first device to the second device at step 23. The second device can authenticate a certificate signature or alternatively authenticate a first device signature at step 24. The second device can also authorize ABOs based on phone numbers at step 25. The phone numbers can be obtained at step 26 by manual entry at the second device, from a contact list in the second device, or from a caller ID decoder at the second device. The second device can authenticate an event by authenticating the signed event with a public key obtained from a certificate obtained from an authentication bonding object at step 29.

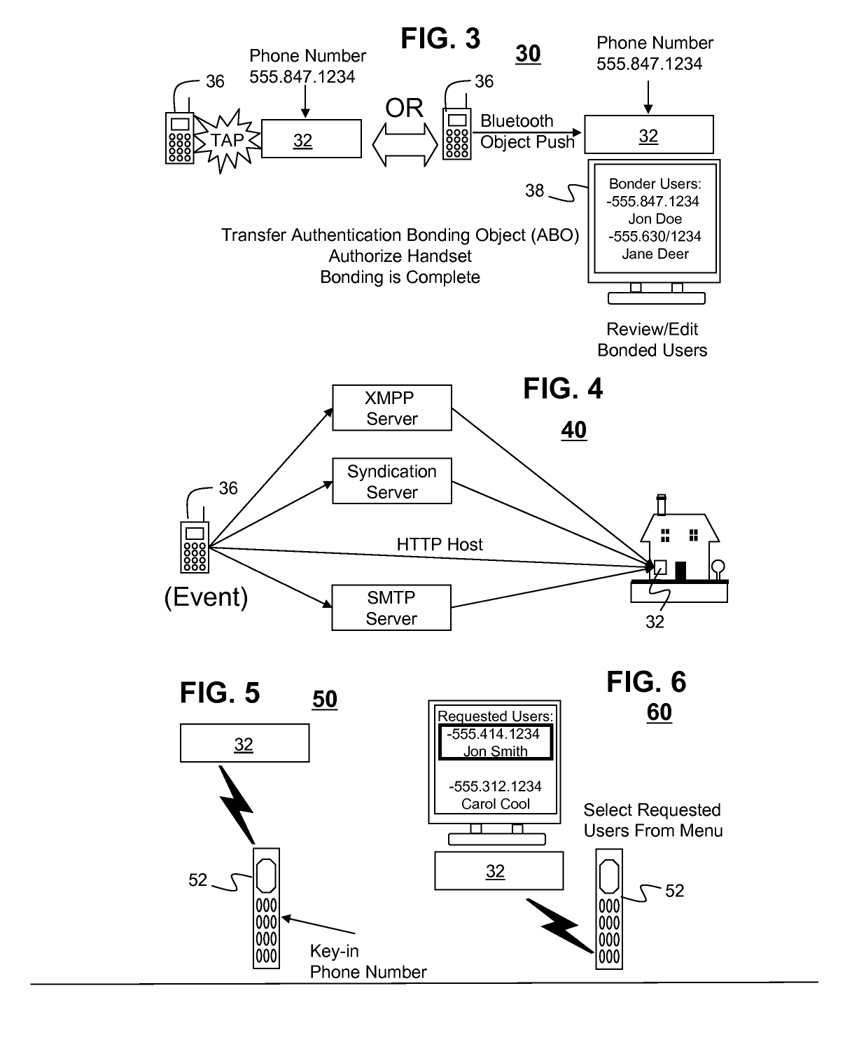

Embodiments herein can be implemented in a wide variety of exemplary ways that can enable a cell phone or handset other wireless device 36 to associate with another device such as a set top box (STB) 32 by transferring a data structure (called an Authentication Bonding Object (ABO)) as illustrated in the system 30 of FIG. 3. The transfer of the ABO can be done transparently using RFID or Bluetooth push technology. In the case of RFID, the two devices 36 and 32 simply tap each other (or come within proximity) to bond. Using Bluetooth, the object push is trivially as simple as sending a business card (which is a well understood operation). A simple case of bonding would be to tap a handset with a set-top box to bond it.

Once the ABO has been sent by a mobile handset 36 for example, it is necessary to authorize the handset 36 that is being bonded on the target device 32 that will be receiving events. Handsets have plenty of unique information associated with them, but much of it is difficult to use (e.g., a public key). This particular embodiment uses the handset's phone number (e.g., 555.847.1234) to complete the authorization step. There are various ways to enter the handset's phone number on a target device such as manual entry (as shown in the system 50 where a remote controller 52 can manually enter or key-In a phone number), automatically using a contact list phone book (as shown in the system 60 of FIG. 6, where the remote controller 52 can selected a requested user from a menu or list) or automatically using caller ID. As shown in the embodiment on the right of FIG. 3, an owner of a STB can review or edit bonded users on a display 38 coupled to the STB 32. In all such cases, the phone number (or other unique identifier such as electronic serial number) of the handset 36 is used on the target device 32 to authorize the handset. An added feature can include the ability to determine what devices are currently bonded together. In the example given, the STB or target device 32 could easily generate a menu listing the phone numbers of the phones it is bonded with on the display 38 for example. Although this may seem simple or obvious, if the devices were bonded with a PIN, there would be no way to identify what devices are bonded.

Note, the concepts demonstrated can be used in different contexts or systems. For example, the handset 36 can be used for bonding and sending events (remotely) to an STB or a PC or for automatic bonding to other handsets in a peer-to-peer system. The handset can also be used for remote bonding of calls placed with metadata.

Once the devices have been bonded and authorized, the handset 36 can send an event to the bonded device 32 as shown in the system 40 of FIG. 4. Importantly, the device 32 receiving the event should be able to authenticate the event to prove it came from the same handset 36 it was bonded with. Using the embodiments herein, the event can be sent using any transport (Bluetooth, 802.11, Ethernet, etc.) over any protocol (HTTP, XMPP, OBEX, SMTP) as long as the transport/protocol supports an “object push” operation.

Embodiments herein can also assume that the only trusted device is the device making the bonding request and sending the events (the handset 36). This arrangement allows bonding with any other device (even untrusted devices or devices that use some other CA). In other words, although secure transport is bi-directional, the embodiments herein has a “trust” that is one direction (the target device trusts the handset), but not the other direction. This allows the target device to be “untrusted” (such as a PC or an STB) which allows the embodiments herein to work with devices that are not trusted while still providing the capability of authenticated events. The final step of the bonding is to authorize devices. This is done by using the phone number of the handset. Since the phone number is in the device certificate, it is authentic information and can be used to authorize the handset

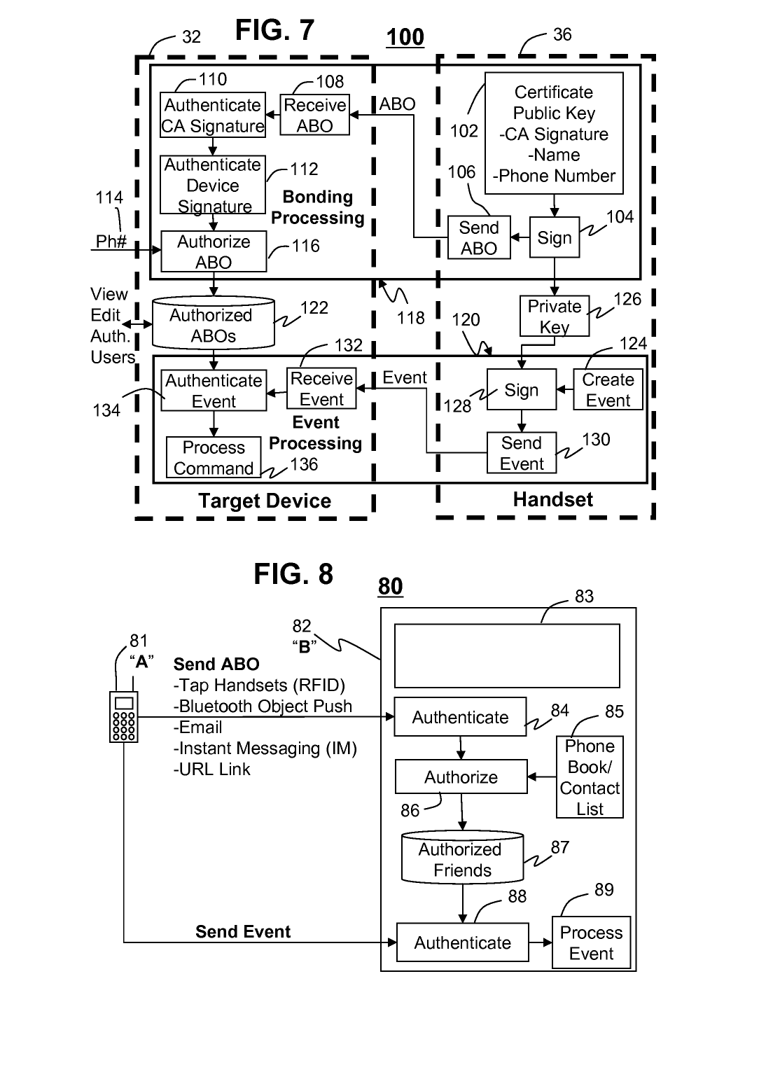

Referring to FIG. 7, a flow chart illustrating a method 100 including the steps among a handset 36 and a target device 32 is illustrated that further details the steps during the bonding processing steps 118 and the event processing steps 120. The method 100 includes sending an authentication bonding object (ABO) at step 106 from the handset 36 to the remote or target device 32. The The ABO can be created by signing at step 104 a certificate public key 102 having a CA signature, a name or a unique phone number. The certificate 102 contains the handset public key and formal name parameters (phone number, name, e-mail, etc.). The CA signs the handset certificate to bind the handset public key to the formal name parameters. The target device 32 can receive the ABO at step 108 and authenticate the ABO. Authenticating the ABO can involve authenticating a CA signature at step 110 which proved the public key belongs to a particular “name” and “phone number”. The target device 32 can further authenticate the device signature which proves the handset 36 owns the private key. Next, the remote device 32 can authorize the handset at step 116 based on the handset's phone number 114 by entering the phone number of the device (36) to authorized. As discussed above, entry of the phone number can be done at the target device by manual entry, selection from a menu or list or phonebook, or by utilizing a caller ID module to extract the phone number. Next, the handset 36 can create an event at step 124, sign the event at step 128, and send signed events at step 130 to the target or remote device 32 where the remote device receives the event at step 132 and authenticates the event at step 134 before processing a command at step 136 related to the event. The signed event sent by the handset 36 can use a private key 126 that is associated with the public key 102. The event may be any type of information such as a recording command, content metadata, or a handset status change as examples. As noted above, the event is signed with the handset private key and sent to the target device which uses its list of authorized ABOs to determine a public key that can authenticate the event signature. If the signature can be authenticated, the target processes the event.

The target device authenticates the ABO to prove that the ABO came from the handset being bonded and that a Certification Agency (CA) has vouched for the information in the certificate can be trusted (e.g. phone number, public key, etc.). Once the ABO has been authenticated on the target 32, the handset needs to be authorized; that is, the target needs to agree to let the handset send events to the target. Authorizing the handset can be done by the target device 32 by agreeing to allow phones having specific phone numbers to send events. As shown in FIG. 7, the owner or user of the target device 32 can view, edit and otherwise maintain a list of authorized ABOs 122. There are various ways for the target device 32 to obtain a list of phone numbers it will authorize. In the case of a Set Top Box (STB), the phone numbers can be obtained using an STB remote control, selecting the phone number from a menu, or entering the phone number on a keypad.

In the case of a target device 82 (or “B”) being another handset as shown in the system 80 of FIG. 8, the target handset's contact list or phone book 85 may be used to find phone numbers of the people it will trust. A display 83 can be used to view such lists or phone books or to view authorized friends corresponding to such phones numbers. Thus, a handset 81 (or “A”) can send an ABO to the target device 82, where the target device or handset device 82 authenticates the handset 81 at step 84 and authorizes the phone number at step 86 using the phone book or contact list 85 in the target device 82. This process creates a list of authorized ABOs or “friends” at step 87. Once the handset has been bonded and authorized, the handset can send an event to the target. If both signatures authenticate, the target device can now authorize the handset to send events. The target device looks through all of the contacts in its phone book or contact list to see if the contact phone number matches the phone number in the formal name information in the certificate in the ABO. If there is a match, the target device authorizes the ABO. The handset can now send events to the target device (the other handset) and the target device will trust the event came from a person that is in their phone book. Using the phone book to auto-authenticate incoming bonding requests is an important consideration with respect to viral propagation of content. It solves the problem of who do I trust (the people in my phone book) and how to authorize them (by phone number). Using the phone number in this scenario enables automatic processing since the phone number is unique to the requesting device. As note above, the event is created and digitally signed by the handset's private key to prove it came from a bonded handset. When the target receives the event, the target can authenticate the signature against the bonded users. Once the signature has been authenticated, the event can be trusted to come from a bonded handset and the event is processed by the target. Thus, when the handset 81 sends an event, the event is authenticated at step 88 before processing a command at step 89 related to the event.

Using phone numbers is in contrast to using a name that may vary in spelling (e.g. Mike, Michael, etc.) and may be difficult to automatically process. An extension to the auto-bonding process is when to authorize events. One can easily add event filtering such that events may be accepted only in particular contexts. An example is that when the handset is at work, it only accepts events from people listed in the “work” contacts. Another possibility is on weekends, the handset only accepts events from people listed in the “family” contacts.

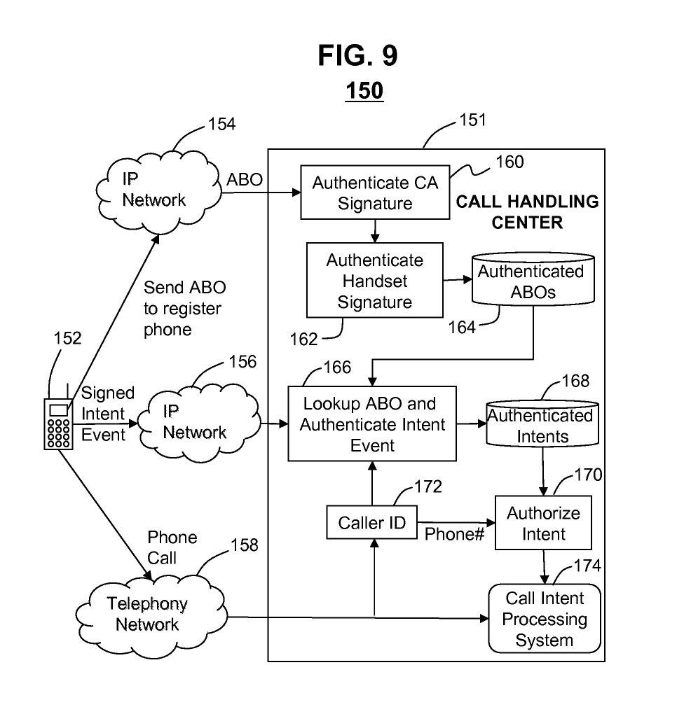

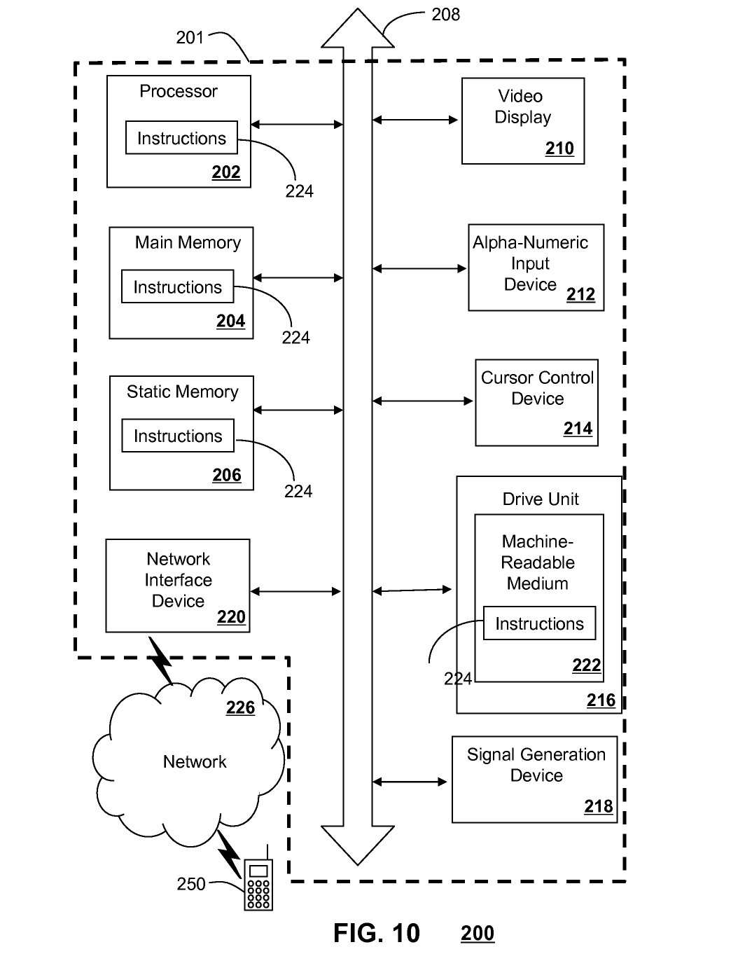

In the case of a call center 151, a system 150 as illustrated in FIG. 9 can use caller ID 172 to determine the identity of a handset 152 placing a call. This scenario operates much in the same way as the other previous examples, where the handset 152 sends an ABO to register the handset via an IP network 154. The call handling center 151 receives the ABO and authenticates a CA signature at step 160 and authenticates the handset signature at step 162 to create a list of authenticated ABO's at step 164. When the handset 152 sends a signed intent event (via IP Network 156 (or the same IP network 154)) to the call center 151, the call center can authenticate the intent event at step 166 by looking up the authenticated ABOs from step 164. A storage of authenticated intents is created at step 168. The call center can further extract the caller ID 177 from a phone call via the telephone network 158 to authorized the intent event at step 170 which will allow the system to proceed with further processing of the event at step 174.

It should be understood that additional security can be included with various embodiments of the invention. Additional security will typically depend on the particular situation and is thus considered optional. Additional security can include event encryption. To encrypt the event from the handset to the target, the target may publish a public key on a public key server. The event may then be sent using PGP encryption. An alternative method to keep the event encrypted is to use HTTPS. Again it should be noted that encryption is beyond scope of the current invention and can be resolved with existing security mechanisms.

Another security issue is replay attack. There are two places replay attacks may occur. The first replay attack is when the ABO is resent. In this case, it simply re-bonds the original handset. This replay attack is not considered an issue (if a handset is already bonded, it can simply throw away the replay attack). The second replay attack is when the event is resent. This is a more serious issue from the point of view that it may cause the target device to do the same thing multiple times. In this situation, existing security measures can include a nonce and a time stamp in the event. In this case, the target device can check to see if the nonce has already been used and discards the event. To garbage collect the nonce list, nonces beyond a particular time can be discarded. For replays, events that are beyond a particular age can be discarded without being used. In summary, replay attacks can be solved with existing technology and is beyond scope of this invention.

Note, the ABO is illustrative from the point of view that there are various ways to represent a device certificate (such as Base64, etc.) and various ways to generate an XML signature. Further note, the CA signature is contains information over the public key and formal name information (name, phone number and e-mail), and, the handset signature is over the certificate. Watching network traffic would show an ABO being transferred. The authorization step would be easily noticed by either entering the phone number or using a menu.

FIG. 2 depicts an exemplary diagrammatic representation of a machine in the form of a computer system 200 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 201 and a sending device 250 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 200 can include a controller or processor 202 (e.g., a central processing unit (CPU), a graphics processing unit (GPU, or both), a main memory 204 and a static memory 206, which communicate with each other via a bus 208. The computer system 200 may further include a presentation device such as a video display unit 210 (e.g., a liquid crystal display (LCD), a flat panel, a solid state display, or a cathode ray tube (CRT)). The computer system 200 may include an input device 212 (e.g., a keyboard), a cursor control device 214 (e.g., a mouse), a disk drive unit 216, a signal generation device 218 (e.g., a speaker or remote control that can also serve as a presentation device) and a network interface device 220. Of course, in the embodiments disclosed, many of these items are optional.

The disk drive unit 216 may include a machine-readable medium 222 on which is stored one or more sets of instructions (e.g., software 224) embodying any one or more of the methodologies or functions described herein, including those methods illustrated above. The instructions 224 may also reside, completely or at least partially, within the main memory 204, the static memory 206, and/or within the processor 202 during execution thereof by the computer system 200. The main memory 204 and the processor 202 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 224, or that which receives and executes instructions 224 from a propagated signal so that a device connected to a network environment 226 can send or receive voice, video or data, and to communicate over the network 226 using the instructions 224. The instructions 224 may further be transmitted or received over a network 226 via the network interface device 220.

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of authentication bonding between communication devices, comprising the steps of:
transferring an authentication bonding object (ABO) from a wireless device to a target device; and
sending unique authorization information from the wireless device to the target device.

2. The method of claim 1, wherein the transfer of the ABO is done using Bluetooth object push or by radio frequency identification (RFID) by placing the wireless device within proximity of the target device.

3. The method of claim 1, wherein the wireless device is a cellular phone and the target device is a set top box, a personal computer, a laptop computer, a call handling center server or a second cellular phone.

4. The method of claim 1, wherein the unique authorization information is a phone number.

5. The method of claim 4, wherein the method further comprises the step of obtaining the phone number by manual entry, by retrieval from a contact list or phone book, or from Caller ID.

6. The method of claim 1, wherein the method further comprises the step of sending an event to the target device, wherein the target device authenticates the event.

7. The method of claim 1, wherein the method further comprises sending an event using any transport over any protocol as long as the transport and protocol support an object push operation.

8. The method of claim 1, wherein the method further comprises the step of generating a list of devices currently bonded together using a list of phone numbers.

9. A method for sending authenticated events from a first device to a second device, the method comprising the steps of:
creating a bond between the first device and the second device;
creating a signed event on the first device; and
sending the signed event from the first device to the second device, wherein the second device authenticates the signed event.

10. The method according to claim 9, wherein creating the bond further comprises the first device signing its device certificate to create an authentication bonding object.

11. The method according to claim 10, wherein the authentication bonding object is transferred from the first device to the second device.

12. The method according to claim 11, wherein the second device authenticates a certificate signature.

13. The method according to claim 11, wherein the second device authenticates a first device signature.

14. The method according to claim 9, wherein the second device authorizes authentication bonding objects based on phone numbers.

15. The method according to claim 14, wherein the phone numbers are obtained by manual entry, from a contact list in the second device, or from a caller ID decoder at the second device.

16. The method according to claim 9, wherein the second device authenticating the event further includes authenticating the signed event with a public key obtained from a certificate obtained from an authentication bonding object.

17. A system for sending authenticated events from a first device to a second device, comprising:
a transceiver or transmitter in the first device; and
a processor coupled to the transceiver or the transmitter, wherein the processor is programmed to:
create a bond between the first device and the second device;
create a signed event on the first device; and
send the signed event from the first device to the second device, wherein the second device authenticates the signed event.

18. The system according to claim 17, wherein the system creates the bond by having the first device sign its device certificate to create an authentication bonding object and by transferring the authentication bonding object from the first device to the second device.

19. The system according to claim 17, wherein the second device authorizes authentication bonding objects based on phone numbers wherein the phone numbers are obtained by manual entry at the second device, from a contact list in the second device, or from a caller ID decoder at the second device.

20. The system of claim 17, wherein the first device is a cellular phone and the second device is a set top box, a personal computer, a laptop computer, a call handling center server or a second cellular phone.
